(19) United States
(12) Patent Application Publication
(10) Pub. No.: US 2011/0059293 A1
(43) Pub. Date: Mar. 10, 2011

(54) Formable Composite Sheet for Material Containment and Transfer

(75) Inventors: Beth P. Powell, State College, PA (US); Robert J. Starr, Tyrone, PA (US); Timothy R. McMillen, Tyrone, PA (US)

(73) Assignee: New Pig Corporation, Tipton, PA (US)

(21) Appl. No.: 12/713,931

(22) Filed: Feb. 26, 2010

Related U.S. Application Data
(60) Provisional application No. 61/155,564, filed on Feb. 26, 2009.

(51) Int. Cl. B32B 3/10; B32B 37/04

(52) U.S. Cl. 428/138; 156/292

(57) ABSTRACT

A formable composite sheet for material containment and transfer is provided which comprises a first plastic or rubber sheet layer, a second plastic or rubber sheet layer, and a metal layer between the first plastic or rubber sheet layer and the second plastic or rubber sheet layer, wherein the metal layer has a plurality of open areas formed therein. A process for making the formable composite sheet is also provided.

### CROSS REFERENCE TO RELATED APPLICATION

This application claims the benefit of U.S. Provisional Patent Application Ser. No. 61/155,564 filed Feb. 26, 2009, which is incorporated herein by reference.

### BACKGROUND OF THE INVENTION

The invention relates generally to a formable composite sheet, and more particularly, to a formable composite sheet for material containment and transfer.

Pans and trays are used to catch drips and leaks from machinery, hoses, valves and parts. Funnels are used to direct liquid transfer. Screens are used to deflect overspray. Pans, trays, funnels and screens are typically made of either molded plastic or fabricated metal.

Molded plastic requires molds and, therefore, sufficient quantities of predetermined sizes to justify the mold expense. Unless made of high-impact resins, the molded plastic is susceptible to cracking if deflected or shocked. Molded plastic also cannot be reformed by the user into different shapes.

Metal can be fabricated into customized shapes and sizes but the raw material and forming labor costs tend to be high. Metal is also heavy and has the tendency to rust and corrode. While stainless steel construction can prevent rust and corrosion, the associated raw material is greater.

### SUMMARY OF THE INVENTION

An aspect of the present invention is to provide a formable composite sheet for material containment and transfer, comprising: a first plastic sheet layer, a second plastic sheet layer, and a metal layer between the first plastic sheet layer and the second plastic sheet layer, wherein the metal layer has a plurality of open areas formed therein.

Another aspect of the present invention is to provide a formable composite sheet for material containment and transfer, comprising: a first rubber sheet layer, a second rubber sheet layer, and a metal layer between the first rubber sheet layer and the second rubber sheet layer, wherein the metal layer has a plurality of open areas formed therein.

A further aspect of the present invention is to provide a process for making a formable composite sheet for material containment and transfer, comprising: providing a first plastic sheet layer, providing a second plastic sheet layer, and providing a metal layer between the first plastic sheet layer and the second plastic sheet layer, wherein the metal layer has a plurality of open areas formed therein.

Another aspect of the present invention is to provide a process for making a formable composite sheet for material containment and transfer, comprising: providing a first plastic rubber layer, providing a second rubber sheet layer, and providing a metal layer between the first rubber sheet layer and the second rubber sheet layer, wherein the metal layer has a plurality of open areas formed therein.

A further aspect of the present invention is to provide a formable composite sheet for material containment and transfer, comprising: a first inner plastic sheet layer, a first outer plastic sheet layer adjacent to the first inner plastic layer, a second inner plastic sheet layer, a second outer plastic sheet layer adjacent to the second inner plastic layer, and a metal layer adjacent to and between the first inner plastic sheet layer and the second inner plastic sheet layer, wherein the metal layer has a plurality of open areas formed therein.

Another aspect of the present invention is to provide a formable composite sheet for material containment and transfer, comprising: a first inner rubber sheet layer, a first outer rubber sheet layer adjacent to the first inner rubber layer, a second inner rubber sheet layer, a second outer rubber sheet layer adjacent to the second inner rubber layer, and a metal layer adjacent to and between the first inner rubber sheet layer and the second inner rubber sheet layer, wherein the metal layer has a plurality of open areas formed therein.

These and other aspects of the present invention will be more fully understood following a review of this specification and drawings.

### BRIEF DESCRIPTION OF THE DRAWINGS

FIG. 1 is an exploded view of a formable composite sheet, in accordance with an aspect of the invention.

FIG. 2 is the formable composite sheet of FIG. 1 as assembled, in accordance with an aspect of the invention.

FIG. 3 is the assembled formable composite sheet of FIG. 2 with a portion of the top layer removed, in accordance with an aspect of the invention.

FIG. 4 is an exploded view of another formable composite sheet, in accordance with another aspect of the invention.

### DETAILED DESCRIPTION

The invention relates generally to a formable composite sheet, and more particularly, to a formable composite sheet for material containment and transfer. In one aspect of the invention, the material for containment, transfer, etc. may be, for example, a liquid material, but it will be understood that the invention is not limited to liquid materials only.

In one aspect, the invention comprises a composite hybrid of plastic or rubber and metal that can be easily formed into material (e.g. a liquid material) collection, transfer and diversion shapes by the end user. The composite combines the lightweight, non-rusting, and non-corroding benefits of plastic or rubber with the non-cracking, customizable shape and size of working with metal. Also, depending on the composition, the composite can be capable of holding a magnetic or allowing a magnetic field to pass through it, thereby allowing the lightweight material to be attached to metal structures with magnets.

An additional benefit of the composite is that it can be shipped, transferred and stored, for example, in a flat sheet or roll. Molded plastic and metal pans and trays must be designed to nest to limit the volume required for storage and transfer. Due to the height of the side walls, the nesting feature only provides benefit if more than one unit is stacked. Since the composite material is formable, the side walls can be raised when needed and then retuned to plane of the material to enable flat sheet or roll storage.

In one aspect of the invention, the composite is formed by fusing plastic or rubber over the surface and into the open areas of a flattened expanded metal. Other options beyond expanded metal include perforated metal, wire screen and wire cloth. Expanded metal is typically less expensive than perforated metal, and the associated alloys tend to more malleable. Wire screen and cloth tend to have an undulating surface due to the associated weaving and can require a thicker plastic to cover and fuse into the open areas. The undulating surface of standard expanded metal is what leads to the preference toward the flattened version. The metal may be, for example, one or more of carbon steel, stainless steel, aluminum, galvanized, tinplate, copper and/or titanium.

In one aspect of the invention, suitable plastic materials include, but are not limited to, thermoplastic materials, such as vinyl, ethylene vinyl acetate, polyethylene, polypropylene, polyurethane, olefins, copolymers and alloys that can be fused with heat and pressure. A suitable plastic material may be, for example Evaloy made be Dupont.

In one aspect of the invention, suitable rubber materials include, but are not limited to rubber casting materials such as, silicone, urethane, nitrile, and natural rubber.

In addition to the described fusing, the plastic and rubber can also be bonded by adhesive through the openings in the metal layer.

The choice of plastic or rubber and expanded metal are interrelated. In choosing plastic, the combined thickness of the films must provide enough volume to fill in the open area of the expanded metal and still provide adequate coverage over the surface of the metal. For example, vinyl does not adhere to the expanded metal, but rather encapsulates it. This allows the metal to bend and reform with limited puckering of the vinyl. The resistance to defection of the expanded metal must be matched to the flexibility of the plastic or rubber. If the plastic or rubber is too flexible for the chosen expanded metal, it will allow the composite to bend at a radius too tight for the expanded metal to endure repeated bends with out breaking. If the plastic or rubber is too stiff for the chosen expanded metal, the composite will not hold its shape and will relax. The overall composite's resistance to deflection must also be balanced. It must be easily formable but also hold its shape with liquid pressure against the walls. If the end user wants to the keep the customized shape and does not desire further ability to flatten, the corners in the customized shape can be solvent bonded, heat welded or adhesively joined. Corners reinforced with these methods add to the final rigidity of the formed shape.

The process of fusing the plastic through the open area of the expanded metal is to use heat and/or pressure to achieve melt flow of the plastic. The melt flow index must be matched to the press conditions. Enough heat, pressure and dwell time must be used to fill the open areas. In one aspect, the process may be a hydraulic, heated, platen press. Other aspects may include vacuum pressing, hot roll lamination, and extrusion coating. A hydraulic, heated, platen press is preferred because higher softening-point thermoplastic films can be chosen to increase temperature resistance, impact strength and resistance to deflection.

The process of fusing rubber through the open area of the expanded metal can either be accomplished by casting or pressing. The casting process would include placing the expanded metal into a mold, pouring the rubber formulation and then curing by chemical reaction or vulcanization. The pressing process would include using uncured rubber sheets, pressing them together, and then curing by vulcanization.

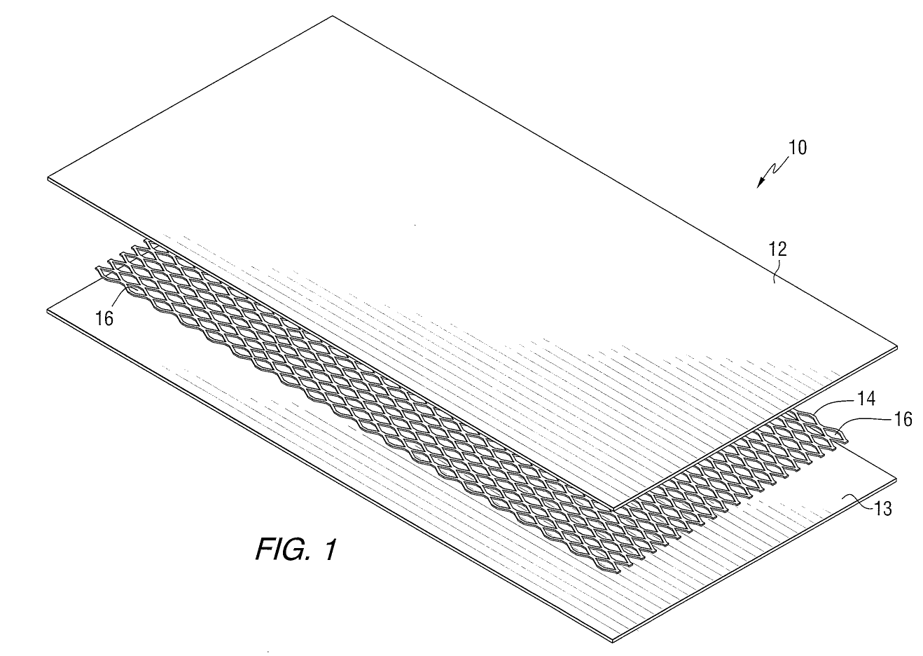

Reference will now be made to the Figures. FIG. 1 is an exploded view of a formable composite sheet 10, in accordance with an aspect of the invention. Specifically, In FIG. 1 there are shown individual layers to be joined together into the composite sheet 10 comprising a first sheet layer 12 and a second sheet layer 13 and a metal forming layer 14 therebetween and having a plurality of open areas 16.

The first sheet 12 and second sheet 13 may be a suitable plastic material or a suitable rubber material, as described herein. The metal layer 14 may be a suitable metal material, as described herein. The open areas 16 allow the plastic or rubber to flow through and fuse together. This allows the user to cut into any area of the laminate.

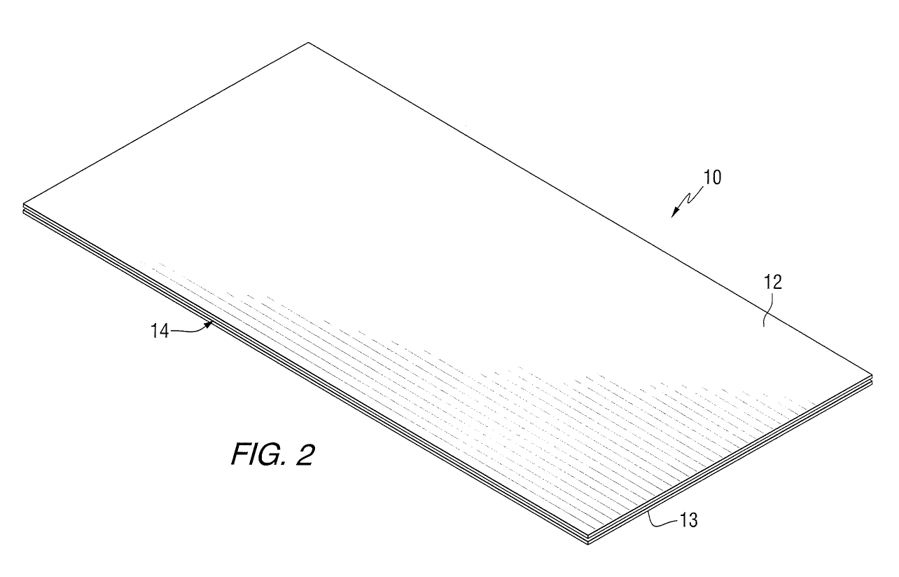

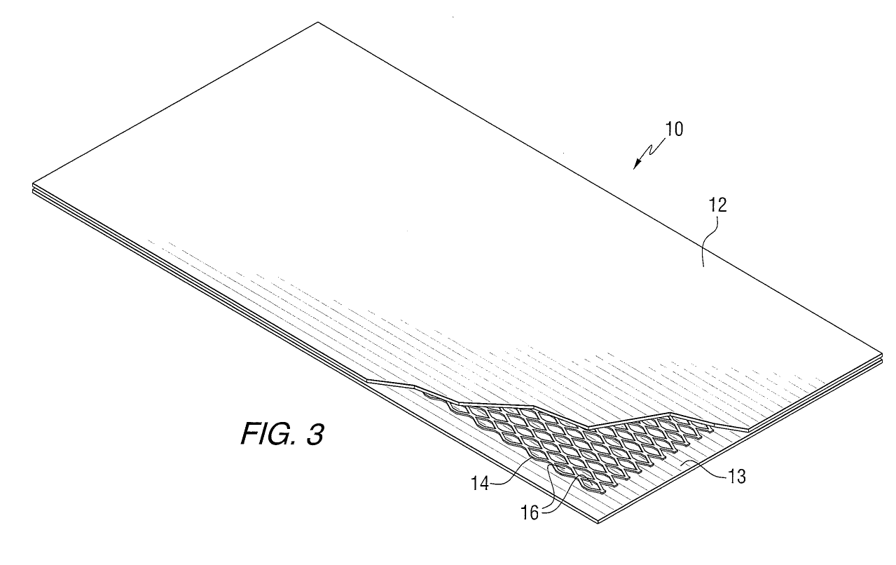

FIG. 2 is the formable composite sheet 10 of FIG. 1 as assembled and FIG. 3 is the assembled formable composite sheet of FIG. 2 with a portion of the top layer 12 removed, in accordance with an aspect of the invention. Specifically, in FIG. 2 there is shown a side view of the encapsulated metal forming layer 14 surrounded by fused plastic or rubber layers 12, 13.

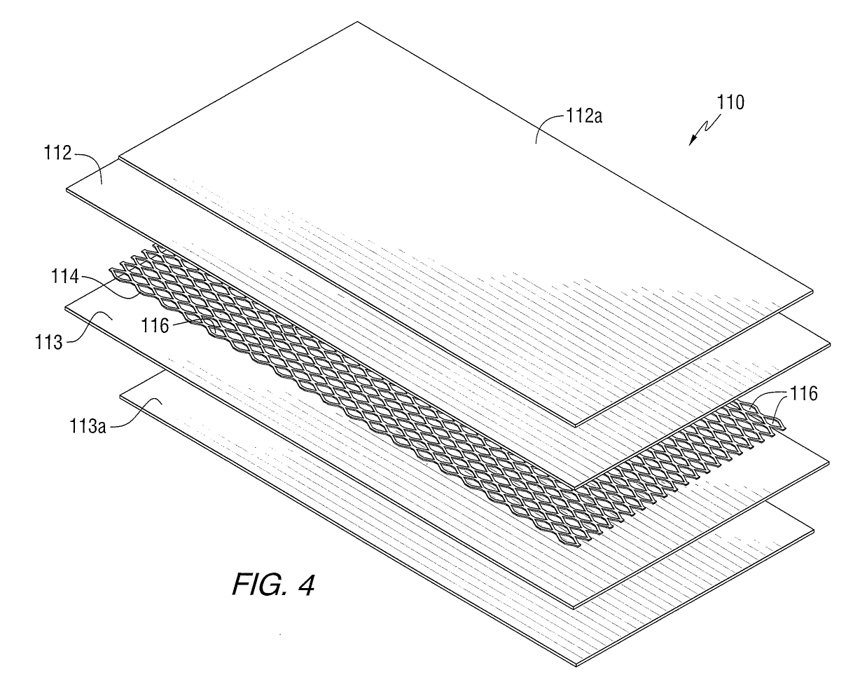

FIG. 4 is an exploded view of another formable composite sheet 110, in accordance with another aspect of the invention. Specifically, In FIG. 3 there are shown individual layers to be joined together into the composite sheet 110 comprising a first inner sheet layer 112 and a second inner sheet layer 113 and a metal forming layer 114 having a plurality of open areas 116. In addition, the composite sheet 110 includes a first outer sheet layer 112a that is positioned on or adjacent the first inner sheet 112, and a second outer sheet layer 113a that is positioned on or adjacent the second inner sheet 113.

The first inner sheet 112 and second inner sheet 113 may be a suitable plastic material or a suitable rubber material, as described herein. The metal layer 114 may be a suitable metal material, as described herein. In addition, the first outer sheet 112a and second outer sheet 113a may be plastic or rubber with enhanced properties, such as abrasion, UV or chemical resistance. These properties are typically obtained through expensive additives or formulations. To control costs, the outer layer should be kept as thin as possible. The outer layers may be sheets that are fused onto the surface with pressure and/or heat. The outer layers may also be coated on the surface, such as with roll coating, spray application, etc.

Example: Inner and outer plastic films: 0.027″ PVC from O'Sullivan Corporation. Metal forming layer: 0.026″ thick A40/G30/Electrogalvinized in a 0.335″ SWD×0.600″ LWD Flattened pattern from Metalex. The materials were pressed together at 290 degrees Fahrenheit, 200 psi on a 4 foot×8 foot platen press and then cooled. There is no prescribed dwell time, rather the process provides for reaching the desired temperature in the center or core and then start the cool down process. The temperature in the center or core may be verified by, for example, placing a thermocouple in contact therewith.

Whereas particular embodiments of this invention have been described above for purposes of illustration, it will be evident to those skilled in the art that numerous variations of the details of the present invention may be made without departing from the invention as defined in the appended claims.

What is claimed is:

1. A formable composite sheet for material containment and transfer, comprising:
a first plastic sheet layer;
a second plastic sheet layer; and
a metal layer between the first plastic sheet layer and the second plastic sheet layer, wherein the metal layer has a plurality of open areas formed therein.

2. The formable composite sheet of claim 1, wherein the first plastic sheet layer is a thermoplastic material.

3. The formable composite sheet of claim 1, wherein the first plastic sheet layer is vinyl, ethylene vinyl acetate, polyethylene, polypropylene, polyurethane, olefins, copolymers or alloys thereof.

4. The formable composite sheet of claim 1, wherein the second plastic sheet layer is a thermoplastic material.

5. The formable composite sheet of claim 1, wherein the second plastic sheet layer is vinyl, ethylene vinyl acetate, polyethylene, polypropylene, polyurethane, olefins, copolymers or alloys thereof.

6. The formable composite sheet of claim 1, wherein the metal layer is at least one of carbon steel, stainless steel, aluminum, galvanized, tinplate, copper and/or titanium.

7. A formable composite sheet for material containment and transfer, comprising:
a first rubber sheet layer;
a second rubber sheet layer; and
a metal layer between the first rubber sheet layer and the second rubber sheet layer, wherein the metal layer has a plurality of open areas formed therein.

8. The formable composite sheet of claim 7, wherein the first rubber sheet layer is silicone, urethane, nitrile, or natural rubber.

9. The formable composite sheet of claim 7, wherein the second rubber sheet layer is silicone, urethane, nitrile, or natural rubber.

10. The formable composite sheet of claim 7, wherein the metal layer is at least one of carbon steel, stainless steel, aluminum, galvanized, tinplate, copper and/or titanium.

11. A process for making a formable composite sheet for material containment and transfer, comprising:
providing a first plastic sheet layer;
providing a second plastic sheet layer; and
providing a metal layer between the first plastic sheet layer and the second plastic sheet layer, wherein the metal layer has a plurality of open areas formed therein.

12. The process of claim 11, further comprising fusing the first plastic sheet layer to the second plastic sheet layer through the open areas of the metal layer.

13. The process of claim 12, further comprising performing the fusing process at a pressure in the range of about 150 psi to about 250 psi.

14. The process of claim 12, further comprising performing the fusing process at a temperature in the range of about 250 degrees Fahrenheit to about 300 degrees Fahrenheit.

15. The process of claim 11, further comprising bonding the first plastic sheet layer to the second plastic sheet layer through the open areas of the metal layer using an adhesive material.

16. A process for making a formable composite sheet for material containment and transfer, comprising:
providing a first plastic rubber layer;
providing a second rubber sheet layer; and
providing a metal layer between the first rubber sheet layer and the second rubber sheet layer, wherein the metal layer has a plurality of open areas formed therein.

17. The process of claim 16, further comprising fusing the first rubber sheet layer to the second rubber sheet layer through the open areas of the metal layer.

18. The process of claim 17, further comprising performing the fusing process at a pressure in the range of about 150 psi to about 250 psi.

19. The process of claim 17, further comprising performing the fusing process at a temperature in the range of about 250 degrees Fahrenheit to about 300 degrees Fahrenheit.

20. The process of claim 16, further comprising bonding the first rubber sheet layer to the second rubber sheet layer through the open areas of the metal layer using an adhesive material.

21. A formable composite sheet for material containment and transfer, comprising:
a first inner plastic sheet layer;
a first outer plastic sheet layer adjacent to the first inner plastic layer;
a second inner plastic sheet layer;
a second outer plastic sheet layer adjacent to the second inner plastic layer; and
a metal layer adjacent to and between the first inner plastic sheet layer and the second inner plastic sheet layer, wherein the metal layer has a plurality of open areas formed therein.

22. A formable composite sheet for material containment and transfer, comprising:
a first inner rubber sheet layer;
a first outer rubber sheet layer adjacent to the first inner rubber layer;
a second inner rubber sheet layer;
a second outer rubber sheet layer adjacent to the second inner rubber layer; and
a metal layer adjacent to and between the first inner rubber sheet layer and the second inner rubber sheet layer, wherein the metal layer has a plurality of open areas formed therein.
